(19) United States
(12) Patent Application Publication
(10) Pub. No.: US 2024/0134854 A1
(43) Pub. Date: Apr. 25, 2024

(54) EXECUTION PACKAGES FOR QUERY GENERATION AND EXECUTION BY DATABASE SYSTEMS

(71) Applicant: Siemens Industry Software Inc., Plano, TX (US)

(72) Inventor: Barry Etter, Mocksville, NC (US)

(73) Assignee: Siemens Industry Software Inc., Plano, TX (US)

(21) Appl. No.: 18/546,461

(22) PCT Filed: Mar. 23, 2021
(86) PCT No.: PCT/US2021/023880

§ 371 Date: Aug. 14, 2023

(51) Int. Cl. G06F 16/2453

(52) U.S. Cl. CPC G06F 16/24542; G06F 16/24547

(57) ABSTRACT

A computing system may include a database system and an application server. The application server may include a logic packaging engine configured to identify a product at a particular stage of a manufacturing process, extract parameter values for the product, and determine processing logic applicable to the product. The processing logic may be designed to query the product database for the product. The logic packaging engine may also be configured to generate an execution package for the database system to perform the query on the product database, and the execution package can include the parameter values for the product at the particular stage in the manufacturing process and metadata references to corresponding query templates stored on the database system.

### BACKGROUND

Computer systems can be used to create, use, and manage data for products and other items. Computer-aided technology (CAx) systems, for instance, may be used to aid in the design, analysis, simulation, or manufacture of products. Examples of CAx systems include computer-aided design (CAD) systems, computer-aided engineering (CAE) systems, visualization and computer-aided manufacturing (CAM) systems, manufacturing operations management (MOM) systems, product data management (PDM) systems, product lifecycle management (PLM) systems, and more. These CAx systems may include components (e.g., CAx applications) that facilitate the design, simulated testing, and management of product structures and product manufacturing.

### BRIEF DESCRIPTION OF THE DRAWINGS

Certain examples are described in the following detailed description and in reference to the drawings.

FIG. 1 shows an example of a computing system that supports execution packages for query generation and execution by database systems.

FIG. 2 shows an example generation of an execution package by an application server.

FIG. 3 shows an example of an execution package that a logic packaging engine may generate.

FIG. 4 shows an example generation of individual database queries via an execution package.

FIG. 5 shows an example of logic that a computing system may implement to support generation of execution packages according to the present disclosure.

FIG. 6 shows an example of logic that a computing system may implement to support query generation and execution via execution packages according to the present disclosure.

FIG. 7 shows an example of a computing system that supports execution packages for query generation and execution by database systems.

### DETAILED DESCRIPTION

Modern CAx can manage products and product manufacturing processes of increasing complexity. As some examples, PLM, PDM, and MOM systems may implement or require data storage systems with complex schema structures to represent business model instances with complex data interdependencies. Modern applications may require such complex data structuring to support various application functionalities. For MOM applications that support automated manufacturing environments, as one example, real-time access of application database systems may be required to provide adequate product support, control, and management of product manufacturing processes.

To support any number of processes or capabilities, modern applications may provide processing logic that is designed to process, track, or control a particular product, for example to manage the product at any number of various stages of a manufacturing process. As used herein, processing logic (also sometimes referred to as business logic) may refer to any type of processing, execution sequence, function, method, or procedure that an application performs for a product. Processing logic may thus include validation procedures, component lookups, security checks, equipment verifications, manufacturing checkpoints or criteria, or any other processing for products, e.g., progressing through various phases of the manufacturing process. At any given stage of a manufacturing process, processing logic for a product may require multiple queries to a product database, for example to validate product components, to update manufacturing checkpoints, or to otherwise manage product manufacturing processes.

As used herein, a query may refer to any function, processing, or access operation performed for a database, including to look up, modify, insert, or delete data stored on the database. Database queries may thus include any type of SQL or other database operation, such as lookups, updates, data insertions, deletions, or modifications, any data manipulation language (DML) function, and more. Such queries may be costly and time-consuming for application computing systems, and real-time manufacturing systems may require precise processing latencies to ensure proper product manufacture across time-sensitive manufacturing stages.

In conventional implementations, many PDM, PLM, or MOM application computing systems include back-end application servers and database systems. Processing logic may be executed at the application servers as product data is received from application clients, manufacturing entities, equipment sensors, or other factory hardware. To perform the database queries required by the processing logic, application servers may generate the required database queries (e.g., SQL statements), and individually transmit each generated database query to back-end database systems. Performance of such conventional implementations may be slow, especially for large database transactions that involve a significant number of entity queries or table updates to a product database. Some techniques exist to perform multiple updates to the same database table with increased efficiency, but such techniques may provide limited benefit to complex product manufacturing processes, in which hundreds or thousands of database tables may be queried by processing logic in a given stage of a manufacturing process.

The disclosure herein may provide systems, methods, devices, and logic for execution packages for query generation and execution by database systems. The execution package technology described herein may provide capabilities for application servers to generate execution packages that allow database systems to locally generate the database queries required by processing logic of PDM, PLM, or MOM applications. Instead of generating and transmitting individual database queries to a database system, application servers can generate an execution package that can be sent as a single network transmission (as compared to hundreds or thousands of separate database queries sent in conventional implementations). As such, the execution package features described herein may reduce network consumption and improve execution latencies in the execution of processing logic. For time-critical manufacturing systems, the improved computing speed and reduced network load on PDM, PLM, or MOM application computing systems may allow for product management and manufacture with increased efficiency and effectiveness.

These and other features and technical benefits of the execution package technology presented herein are described in greater detail next.

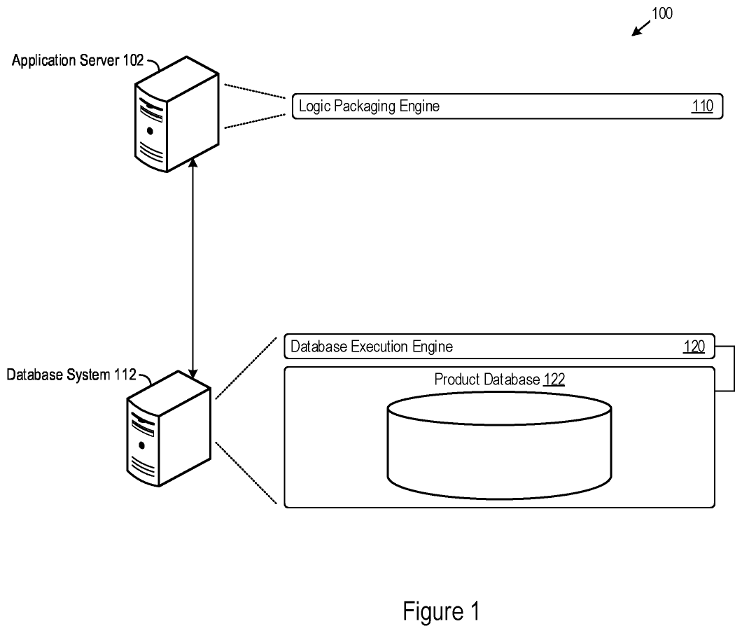

FIG. 1 shows an example of a computing system 100 that supports execution packages for query generation and execution by database systems. The computing system 100 may take the form of multiple computing devices such as application servers, compute nodes, desktop or laptop computers, smart phones or other mobile devices, tablet devices, embedded controllers, and more. In some implementations, the computing system 100 forms the back-end implementation of a PDM, PLM, MOM, or any other CAx application, and may thus include any number of application servers and database systems.

In the example shown in FIG. 1, the computing system 100 includes an application server 102 and a database system 112. The application server 102 may include any number of computing devices and may interface with application clients or other application components. The database system 112 may include any number of computing devices and may refer to any computing entity that implements an application database or otherwise stores application data, such as the product database 122 shown in FIG. 1. The product database 122 may take the form of any data storage entity that stores product data, and may be implemented as a relational database management system (RDBMS) or any other type of data system.

In some implementations, the application server 102 and database system 112 are logically and physically distinct, for example implement through different computing devices. Communication between the application server 102 and database system 112 may be performed across any number of communication networks, such as wired or wireless local area networks, Ethernet links, or the Internet. Together, the application server 102 and database system 112 may provide various back-end application capabilities in client-server application architectures of PDM, PLM, and MOM application systems. For instance, the application server 102 and the database system 112 may provide processing logic capabilities to support the control, management, and processing of various stages of a real-time manufacturing process of a MOM application.

As an example implementation to support any combination of the execution package features described herein, the computing system 100 shown in FIG. 1 includes a logic packaging engine 110 (implemented by the application server 102) and a database execution engine 120 (implemented by the database system 112). The computing system 100 may implement the engines 110 and 120 (including components thereof) in various ways, for example as hardware and programming. The programming for the engines 110 and 120 may take the form of processor-executable instructions stored on non-transitory machine-readable storage mediums and the hardware for the engines 110 and 120 may include processors to execute those instructions. A processor may take the form of single processor or multi-processor systems, and in some examples, the computing system 100 implements multiple engines using the same computing system features or hardware components (e.g., a common processor or a common storage medium).

In operation, the logic packaging engine 110 may identify a product at a particular stage of a manufacturing process, extract parameter values for the product at the particular stage of the manufacturing process, and determine processing logic applicable to the product at the particular stage of the manufacturing process. The processing logic may be designed to query the product database 122 for the product based on the parameter values for the product at the particular stage of the manufacturing process. The logic packaging engine 110 may also generate an execution package for the database system 112 to perform the query on the product database 122 based on the parameter values of the product, and the execution package may include the parameter values for the product and metadata references to corresponding query templates stored on the database system 112. The logic packaging engine 110 may then send the execution package to the database system 112.

In operation, the database execution engine 120 may receive the execution package from the application server 102, generate individual database queries via the execution package, and execute the individual database queries to perform the query to the product database 122 specified by the processing logic for the product at the particular stage of the manufacturing process.

These and other execution package features are described in greater detail next. Many of the execution package features herein are presented in the context of MOM application systems, as illustrative examples. However, any of the described execution package features may be consistently relevant, applicable, and implemented for backend computing systems for applications of any type.

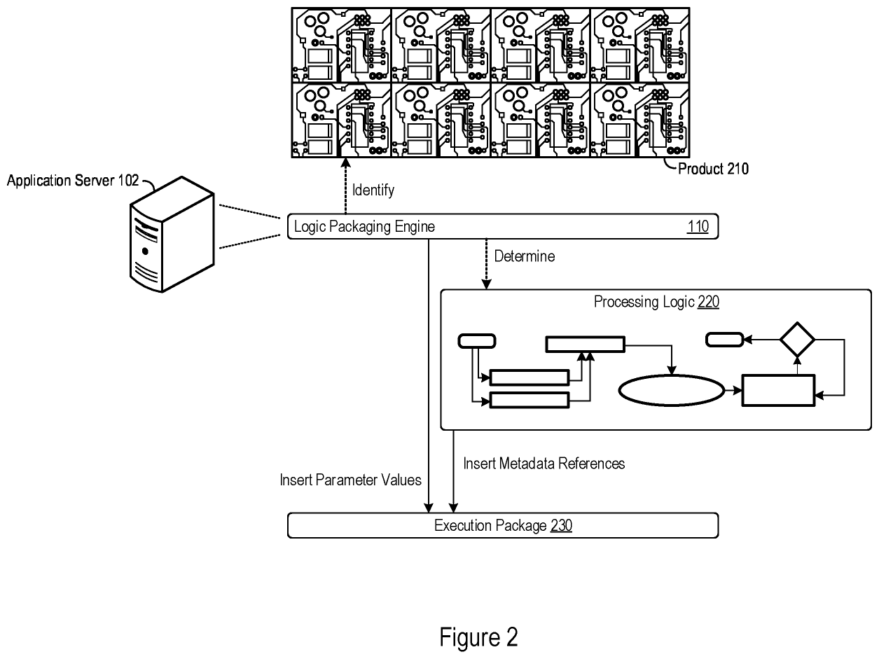

FIG. 2 shows an example generation of an execution package by an application server. In the example shown in FIG. 2, the application server 102 implements the logic packaging engine 110, and the logic packaging engine 110 may support various product identification, processing logic determination, and execution package generation features as disclosed herein. As the application server 102 may be part of a backend implementation of a PDM, PLM, or MOM application, the logic packaging engine 110 may support operations management of product manufacturing processes.

The logic packaging engine 110 may identify a product, such as the product 210 in FIG. 2. In the example of FIG. 2, the product 210 is a circuit wafer. In this specific example, the logic packaging engine 110 may support a fabrication process of integrated circuit (IC) wafers at a circuit foundry, though products of any type, complexity, or industry are contemplated herein. Circuit wafers are just one of a near-countless number of products that a PDM, PLM, or MOM application can manage, and the execution package technology described herein may be applicable to any type of product or product manufacturing process, and is not limited to any particular product type or any specific manufacturing process.

Applications can manage manufacturing operations at any point in a manufacturing process, and the logic packaging engine 110 may tailor product processing and management specifically to particular stages of product manufacturing processes. As such, the logic packaging engine 110 may identify a particular stage in a manufacturing process that the product 210 is at, e.g., a particular point in a circuit fabrication process that the IC wafer is at. Manufacturing stage identifications by the logic packaging engine 110 may be tracked through sensor point data provided along a manufacturing line, responsive to bar code scans, user-provided application inputs, application client transmissions, or in any number of various other ways. In some implementations, the logic packaging engine 110 may identify the product 210 and the particular stage in a manufacturing process that the product 210 is at via input data received from application clients.

The logic packaging engine 110 may determine processing logic applicable to the product 210, and specifically for a particular stage in a manufacturing process that the product 210 may be at. Processing logic may vary based on a specific product and the particular stage of a manufacturing process that the product is at, and the logic packaging engine 110 may perform any type of lookup or logic retrieval procedure in order to determine the specific processing logic applicable to the product 210 at the particular stage of the manufacturing process. In some instances, processing logic of a PDM, PLM, or MOM applications may be configurable. For instance, processing logic may be implemented as pre-designed blocks of logic that can be arranged by end users or system administrators into configurable arrangements that can vary by product type, manufacturing process, or any other delineating product characteristic. In that regard, PDM, PLM, or MOM applications can allow for flexible specification of nearly any type of logic and customized processing that need not be expressly hard-coded by application end users. Configurable processing logic can be tailored for specific product types and at different manufacturing process stages, allowing design freedoms, flexible validations, and processing flows, each customizable to meet the requirements of for a variety of product types and for various manufacturing process requirements, criteria, and checkpoints.

The flexibility that configurable processing logic can provide may result in complex processing sequences for products, even for relatively simple stages of a manufacturing process. Depending on the industry and product type, processing logic can include product functions, updates, or validations that require hundreds or thousands of database queries to a product database (which may include database lookups, updates, modifications, deletions, insertions, or any other database transaction). In conventional application implementations, processing logic may be executed by application servers that interface with application clients. For processing logic requiring database queries, conventional application servers may generate the required database queries (e.g., SQL statements that lookup or modify product data) and transmit the individual database queries to database systems for execution. As noted herein, database queries may include any type of database transaction, whether to lookup product data, modify product data, etc. For complex processing logic involving large numbers of database transactions to multiple different database entities (e.g., tables), application performance can lag due to network latency bottlenecks caused by large numbers of query transmissions between application servers and database systems. Such lags in performance may cause issues in real-time automated manufacturing environments that require high-speed executions with requisite precision to ensure proper manufacturing of complex product structures.

The logic packaging engine 110 may address the network and execution bottlenecks that can plague conventional computing systems, and may do so by generating execution packages instead of individual database queries to send to a database system in order to effectuate the queries to product databases required by processing logic of a particular product. To illustrate through the example in FIG. 2, the logic packaging engine 110 may determine that the processing logic 220 is applicable to the product 210 at the particular manufacturing stage that the product 210 is at. The processing logic 220 may be designed to query a product database 122 for the product 210 based on the parameter values for the product 210 at the particular stage of the manufacturing process, doing so to perform specific functions or capabilities designed for the processing logic 220 to execute for the product 210 at this particular manufacturing stage.

As a continuing example referenced herein, the product 210 may be an IC wafer, and at a particular staging in an IC fabrication process, the processing logic 220 for the product 210 may specify disassociating the individual IC chips on the wafer into individual database objects in the product database. A single IC wafer in modern fabrication processes can include hundreds or thousands of individual IC chips (or more). Consequently, the processing logic 220 for the product 210 at this specific stage in the fabrication process may require thousands of individual database insert operations to be performed for new product database objects to track each of the individual IC chips of the IC wafer. Put another way, the processing logic 220 for the product 210 at this particular stage in the manufacturing process may require generation and execution thousands of individual database queries (in this case, insert operations) by a database system 112 that implements the product database 122 for the product 210.

In this example, the logic packaging engine 110 need not generate the thousands insert operations and individually transmit each of the insert operations for execution by the database system 112. Instead, the logic packaging engine 110 may generate an execution package 230 to transmit to the database system 112, which may cause the database system 112 to generate the required insert operations that include the specific parameter values of the product 210. The logic packaging engine 110 may generate the execution package 230 as a light-weight object that includes parameter values for the product 210 to be used in any database queries required by the processing logic 220 as well as metadata references to corresponding query templates stored on the database system 112 itself.

In some sense, the logic packaging engine 110 may generate the execution package 230 to include any data or logic that supports execution of (at least a portion of) the processing logic 220 locally on the database system 112 instead of remotely on an application server. That is, instead of query generation on an application server remote to the product database 122, the execution package technology described herein may support local query generation and execution at the database system 112 itself, which may improve application performance, decrease network consumption, and increase the application execution speed and efficiency of PLM, PDM, or MOM computing systems.

The logic packaging engine 110 may generate the execution package 230 to include any information needed for a database system to generate and execute any database queries required by the processing logic 220. As database queries of processing logic 220 may be specific to the product 210 and a particular manufacturing stage, the logic packaging engine 110 may extract any relevant parameter values for the product 210, the manufacturing stage, contextual information, or any other relevant data needed for the database queries required by the processing logic 220. Example parameter values of the product 210 that the logic packaging engine 110 may insert into the execution package 230 include product IDs, validation parameter values, and more. An application server may receive any number product parameter values from application clients, application components, or other entities monitoring a manufacturing process for the product 210, and any such relevant data may be obtainable by the logic packaging engine 110 since such data would be needed to generate database queries under conventional implementations. Each database transaction or query required by the processing logic 220 may have specific parameter values for the product 210 or manufacturing stage for which to use in database queries to a product database 122, and the logic packaging engine 110 may insert any such parameter data into the execution package 230.

As another example, the logic packaging engine 110 may insert metadata references to corresponding query templates stored on the database system 112. The metadata references may refer to any identifier, lookup value, reference, or other information that identifies a particular database query. In particular, a metadata reference may identify a particular query template supported by an application, and query templates may be used as a baseline, foundation, or skeleton to construct individual database queries specific to a particular product, manufacturing stage, and processing logic. As used herein, a query template may refer to any database query that performs a database operation, but without at least some specific parameter values populated in the query template. As such, query templates may provide templates for any number or type of database operations and transactions, such as updates, lookups, data insertions, data deletions, data modifications, and the like.

Corresponding query templates may be stored, pre-configured, or otherwise accessible to a database system 112, and the corresponding query templates may support or implement database functions required for execution of any processing logic supported by an application. Corresponding query templates stored on the database system 112 can be combined with specific parameter values for a product to form individual database queries required by processing logic, and the individual database queries generated from execution packages can then be executed to perform any required database transactions of identified processing logic for the product 210.

In some examples, the metadata references that the logic packaging engine 110 may insert into an execution package 230 may reference applicable corresponding query templates accessible by a database system 112. The logic packaging engine 110 may thus generate the execution package 230 by determining, from the processing logic 220 applicable to the product 210, any corresponding query templates required to perform any query on the product database 122 specified by the processing logic 220 for the product 210 at the particular stage of the manufacturing process. Then, the logic packaging engine 110 may retrieve the metadata references that identify these corresponding query templates, for example through a lookup table or through any other reference data to identify the metadata references. In some implementations, the processing logic 220 itself may include, reference, or identify the specific metadata references (and thus specific query templates) required to perform the processing logic 220. In such cases, the logic packaging engine 110 may extract the metadata references from the processing logic 220, and the logic packaging engine 110 may further insert identified metadata references into the execution package 230.

As yet another example, the logic packaging engine 110 may insert logic flows into the execution package 230. A logic flow may refer to any form of logic applicable to generation of database queries via the execution package 230. Logic flows can be hard-coded and may include loops, conditional statements (e.g., if/then statements), or any other logic that itself may be part of the processing logic 220 and transferred to a database system 112 for execution through the execution package 230. In some examples, the logic packaging engine 110 inserts a logic flow applicable to a particular corresponding query template for the product 210, and the logic flow may cause a database system 112 to execute the particular corresponding query template multiple times with a different parameter value for the product 210 for each execution.

Returning to a continuing example for disassociating individual IC chips from an IC wafer, the logic packaging engine 110 may insert a logic flow in the execution package 230 to cause a database system to execute a loop to generate the (up to) thousands of individual database queries needed to disassociate the individual IC chips into individual database objects in a product database. An execution package 230 generated by the logic packaging engine 110 to perform this disassociation function may include a loop, wherein each loop iteration generates an individual database query to insert a database object for a particular IC chip. As each loop iteration may be generate an individual database query for a different IC chip, the particular product parameter value applied for each loop iteration may differ (e.g., a different particular chip ID for each loop iteration, which may be specified through product parameter values inserted into the execution package 230 by the logic packaging engine 110). This example of a logic flow in the form of a loop may be executed by a database system 112, and after execution of (up to thousands of) the loop iterations, a separate database query may be generated for each individual IC chip of the IC wafer.

Logic flow insertions into execution packages may improve application and computing system performance, as logic execution and query generation locally on a database system 112 may eliminate the need to send up to thousands of different queries between an application server 102 and database system 112. Moreover, logic flows may increase the storage efficiency or reduce the memory footprint of execution packages. Instead of generating separate metadata references and parameter values for each individual IC chip of a product 210, the logic packaging engine 110 may instead include a single instance of a metadata reference to the required query template and a loop logic flow. Reduced memory footprints may increase the speed at which the logic packaging engine 110 generates execution packages and reduce the network bandwidth requirements to communicate generated execution packages, technical improvements that can improve the efficiency of application computing systems.

As a further example of information that can be inserted into an execution package, the logic packaging engine 110 may include any contextual information for the processing logic 220. Contextual information may include any relevant aspect, data, or parameter for the product 210, the particular manufacturing stage that the product 210 is at, or any other aspect of the processing logic 220. Examples of contextual information include a transition ID, timestamps, or any other high-level information. In some instances, contextual information may be stored as global variables in the execution package 230. Additionally or alternatively, the logic packaging engine 110 may insert global variables into the execution package 230 that are applicable to multiple of the corresponding query templates referenced in the execution package 230 or that represent product parameter values used at multiple different points in the execution package 230.

While some examples have been presented as to types of information that the logic packaging engine 110 may include in an execution package, the present disclosure contemplates any relevant data to be inserted into execution packages to support or effectuate query generation and execution on database systems. Execution packages generated by the logic packaging engine 110 may include contextual information, logic flows, metadata references, parameter values used in corresponding query templates, or any other type of relevant data. Upon or after generation of an execution package, the logic packaging engine 110 may send the generated execution package to a database system 112 for query generation and execution. As such, execution package technology may support query generation and execution locally on database systems instead on application servers, which may improve application efficiency, reduce execution latencies and network consumption, and improve the speed and capability of application computing systems.

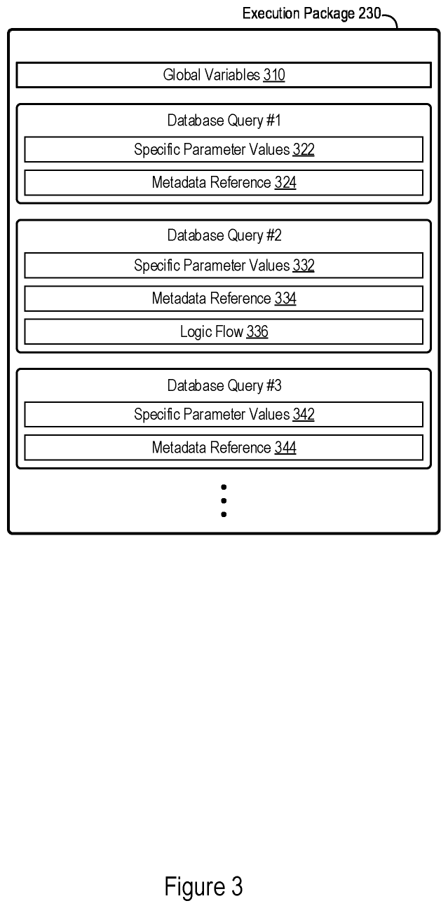

FIG. 3 shows an example of an execution package that the logic packaging engine 110 may generate. In the example of FIG. 3, the execution package 230 is shown with various components, structure, and information inserted and formed by the logic packaging engine 110. The logic packaging engine 110 may generate the execution package 230 in any type of data or container format, for example as an eXtensible Markup Language (XML) document, a Javascript Object Notation (JSON) file, or in any other applicable data format.

The execution package 230 shown in FIG. 3 includes global variables 310. The global variables 310 may include any value that can be used in multiple points of the execution package 230, and may thus be defined in the execution package 230 as a global variable as opposed to variable value tied only to a particular database query, logic flow, or other specific point in the execution package 230. Also in FIG. 3, the logic packaging engine 110 generates the execution package 230 such that different database queries required by processing logic are delineated in the execution package 230 into distinct sections of the execution package 230. For instance, each section of an execution package 230 applicable to a different corresponding query template may be delineated into a separate partition or section in the execution package 230.

The different corresponding query templates referenced in the execution package 230 may be numbered or otherwise ordered (e.g., as database query #1, #2, and #3 in the example shown FIG. 3), and the ordering, structure, or layout of the execution package 230 may reflect an execution order for individual database queries generated from the execution package 230. In this example, an execution order of the execution package 230 may specify that database query #1 of the execution package be executed prior to database query #2, and so forth. That is, the ordering of sections in the execution package 230 may (e.g., implicitly) specify an execution order for database queries generated from the execution package 230. Additionally or alternatively, the execution package 230 may expressly specify an execution order of database queries generated from the execution package 230. Section differentiations in the execution package 230 may be achieved through delineators supported by XML, JSON, or any other data interchange or file format.

For each of the corresponding query templates referenced in the execution package 230, the logic packaging engine 110 may insert relevant data for generation and execution of an individual database query (or multiple database queries through logic flows) through the corresponding query template. The logic packaging engine 110 may, in generating the execution package 230, link specific parameter values for the product 210 to a particular corresponding query template that uses the specific parameter values. As an example shown in FIG. 3, the execution package 230 includes specific parameter values 322 and a metadata reference 324 that are specific to a database query labeled as database query #1. The metadata reference 324 may identify a specific query template applicable to database query #1 and the specific parameter values 322 may specify the relevant parameter values applicable to database query #1. As described in greater detail herein, the specific parameter values 322 and the query template referenced by the metadata reference 324 may be combined to form database query #1, which may be an individual database query to be executed as part of the processing logic 220 for which the execution package 230 was generated. Note that generation of database query #1 may additionally include insertion of any global variables 310 applicable to this individual database query as well.

As noted herein, the logic packaging engine 110 may insert logic flows into execution packages, including logic flows applicable to a specific metadata reference (and thus a specific query template stored on a database system 112). In the example of FIG. 3, the execution package 230 includes a section for database query #2, which includes specific parameter values 332, a metadata reference 334, and a logic flow 336 applicable to generation and execution of database query #2. The logic flow 336 may cause the generation of multiple database queries, and database query #2 of the execution package 230 may cause the generation and execution of multiple individual database queries by the database system 112, for example as loop logic that causes generation of thousands of individual database queries required to disassociate individual IC chips from an IC wafer. Each loop iteration may use the query template referenced by the metadata reference 334 for database query #2, and use a different one of the specific parameter values 332 (e.g., a different chip ID specified in the specific parameter values 332) for each loop iteration.

The execution package 230 shown in FIG. 3 also includes section for database query #3, for which the execution package 230 includes specific parameter values 342 and a metadata reference 344.

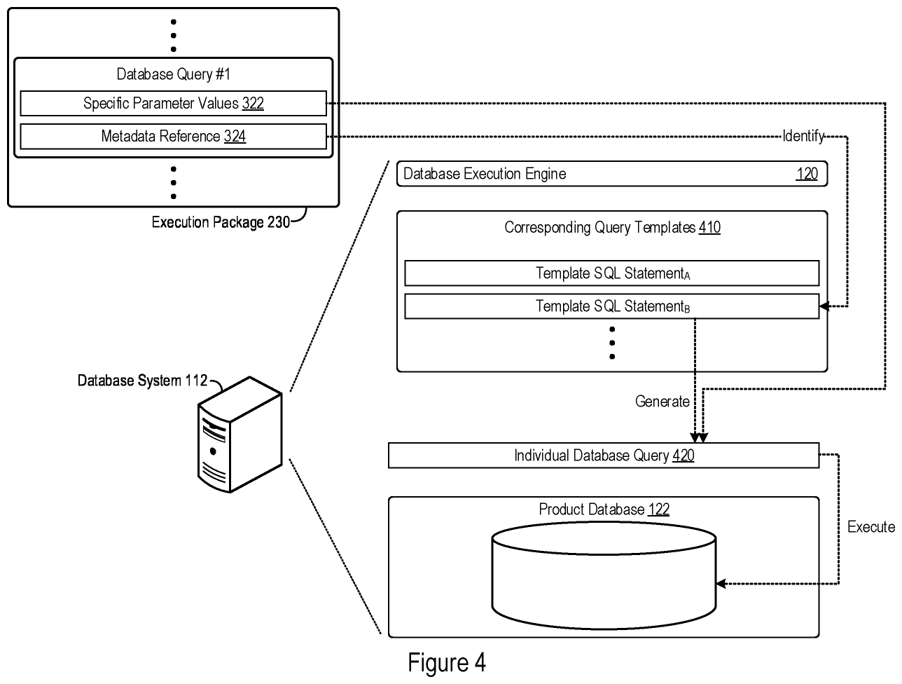

In FIG. 3, one example of an execution package layout, contents, and structure is illustrated, though any number of variations are contemplated herein. Upon or after generation, the logic packaging engine 110 may send the execution package 230 to a database system 112 for query generation and execution. Query generation and execution by database systems via execution packages is discussed in greater detail next with reference to FIG. 4.

FIG. 4 shows an example generation of individual database queries via an execution package. In the example of FIG. 4, a database system 112 receives the execution package 230, and may generate individual database queries from the execution package 230. The database system 112 may implement the database execution engine 120, which may support, implement, or provide any combination of the query generation or execution features as described herein for the execution package technology.

The database execution engine 120 may generate individual database queries from a received execution package. To do so, the database execution engine 120 may retrieve, from an execution package, any specific parameter values, global variables, logic flows, metadata references, or other relevant information needed to construct individual database queries. To illustrate through FIG. 4, the database execution engine 120 may generate an individual database query for a section of the execution package 230 delineated for database query #1 of processing logic 220. In FIG. 4, the database execution engine 120 obtains the specific parameter values 322 and the metadata reference 324 included in the execution package 230 marked as applicable to database query #1.

The database execution engine 120 may identify a particular corresponding query template referenced by the metadata reference 324 of the execution package 320, doing so from among a set of corresponding query templates 410 stored on or otherwise accessible by the database system 112. The corresponding query templates 410 may be stored by the database system 112 in any data structure, such as a table, lookup structure, or query database implemented to store query templates that support processing logic of a PLM, PDM, or MOM application. As noted herein, the corresponding query templates 410 may be in the form of query templates for specific database operations, but without specific parameter values. The corresponding query templates 410 may correlate to specific functions, operations, or capabilities of processing logic. Referring to a continuing example herein, one of the corresponding query templates may be a query template to insert a new database object into the product database 122 for individual IC chips disassociated from an IC wafer at a particular step in a circuit fabrication process. Each corresponding query template may be configured, loaded, or specified in the database system 112 in support of the various capabilities, functions, flows, or processes implemented by the processing logic of an application. As processing logic can be configurable and complex, the corresponding query templates 410 may be continually updated or modified to support evolving configurable processing logic features of an PDM, PLM, or MOM application.

Each of the corresponding query templates 410 stored in database system 112 may be assigned a specific reference value, e.g., a metadata reference. The database execution engine 120 may identify corresponding query templates specifically referenced in an execution package through stored metadata references. For database query #1 of the execution package 230, the database execution engine 120 may identify a particular corresponding query template from among the corresponding query templates 410, doing so via the metadata reference 324 specified for database query #1 in the execution package 230. For instance, the metadata reference 324 may serve as a lookup key for a lookup table or other data structure storing the corresponding query templates 410, and the database execution engine 120 may retrieve a particular corresponding query template identified by the metadata reference 324. In the example of FIG. 4, the database execution engine 120 retrieves a particular corresponding query template labeled as template SQL statementB from the corresponding query templates 410.

The database execution engine 120 may insert parameter values included in the execution package 230 into identified corresponding query templates to form the individual database queries to execute on the database system 112. The individual database queries may perform any type of database transaction on the product database 122, including data lookups, data modifications, and more. In the example of FIG. 4, the database execution engine 120 may insert the specific parameter values 322 included in the execution package 230 into template SQL statementB of the corresponding query templates 410 to form the individual database query 420. If needed or specified by the execution package 230, the database execution engine 120 may insert global variables or execute logic flows (which may result in generation of multiple individual database queries). Through a retrieved corresponding query template and insertion of specific parameter values, the database execution engine 120 may generate an individual database query 420 of the processing logic 220 for a product 210, and may do so locally on the database system 112 instead of on an application server 102. Then, the database execution engine 120 may execute the individual database query 420 on the product database 122. Doing so may effectuate a query required by the processing logic 220 for the product 210 at a particular manufacturing stage (e.g., a data modification), and do without having to generate and transmit the individual database query 420 from an application server to the database system 112.

In any such a manner, the database execution engine 120 may generate individual database queries from execution packages through parameter values, metadata references, contextual information, logic flows and global variables stored in the execution package. An execution order of generated individual database queries may be specified by the execution package 230, and the database execution engine 120 may execute the generated individual database queries in the specified execution order. Thus, the database execution engine 120 may generate individual database queries from an execution package, and execution of the generated individual database queries may effectuate required database transactions of processing logic for a product at a particular stage in a manufacturing process. Any results, validations, lookups, or other response data for the required query of the processing logic may be packaged by the database execution engine 120 and sent to an application server that provided the execution package.

In the various ways described herein, execution package technology may support local generation and execution of database queries on a product database. In contrast to query generation and transmission from application servers, the execution package technology described herein may provide an efficient and elegant solution to reduce network latencies, improve application execution speeds, and increase computing system performance as compared to conventional application implementations.

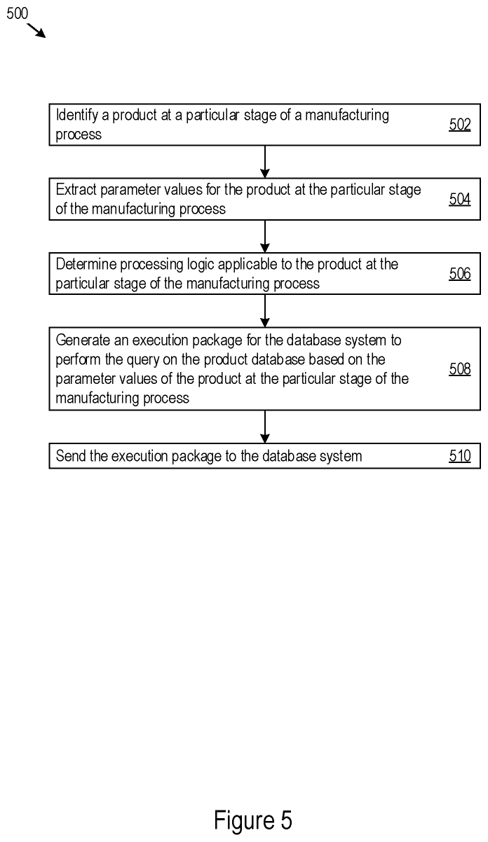

FIG. 5 shows an example of logic 500 that a computing system may implement to support generation of execution packages according to the present disclosure. For example, the computing system 100 may implement the logic 500 as hardware, executable instructions stored on a machine-readable medium, or as a combination of both. An application server 102 of the computing system 100 may implement the logic 500 via the logic packaging engine 110, through which the computing system 100 may perform or execute the logic 500 as a method to support generation of execution packages for query generation and execution by databases systems. The following description of the logic 500 is provided using the logic packaging engine 110 as an example. However, various other implementation options by systems are possible.

In implementing the logic 500, the logic packaging engine 110 may identify a product at a particular stage of a manufacturing process (502) and extract parameter values for the product at the particular stage of the manufacturing process (504). The logic packaging engine 110 may further determine processing logic applicable to the product at the particular stage of the manufacturing process (506), and the processing logic may be designed to query a product database for the product based on the parameter values for the product at the particular stage of the manufacturing process. The logic packaging engine 110 may generate an execution package for a database system to perform the query on the product database based on the parameter values of the product at the particular stage of the manufacturing process (508), and the execution package may include the parameter values for the product at the particular stage in the manufacturing process and metadata references to corresponding query templates stored on the database system. Then, the logic packaging engine 110 may send the execution package to the database system (510).

The logic 500 shown in FIG. 5 provides an illustrative example by which an application server 102 may support generation of execution packages. Additional or alternative steps in the logic 500 are contemplated herein, including according to any of the various features described herein for the application server 102, logic packaging engine 110, database system 112, database execution engine 120, and any combinations thereof.

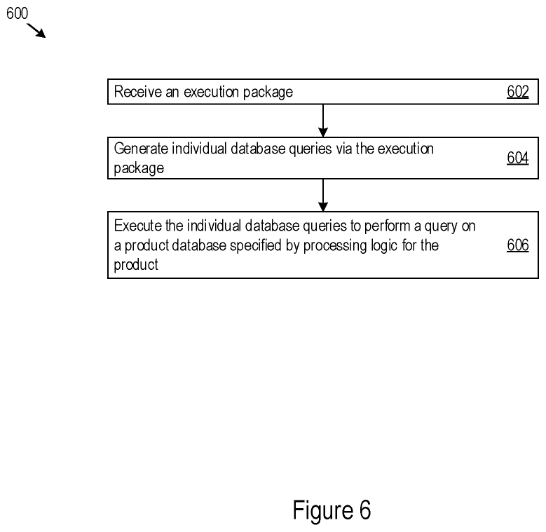

FIG. 6 shows an example of logic 600 that a computing system may implement to support query generation and execution via execution packages according to the present disclosure. For example, the computing system 100 may implement the logic 600 as hardware, executable instructions stored on a machine-readable medium, or as a combination of both. A database system 112 of the computing system 100 may implement the logic 600 via the database execution engine 120, through which the computing system 100 may perform or execute the logic 600 as a method to support query generation and execution on database systems through execution package generated by application servers. The following description of the logic 600 is provided using the database execution engine 120 as an example. However, various other implementation options by systems are possible.

In implementing the logic 600, the database execution engine 120 may receive an execution package (602) and generate individual database queries via the execution package (604). To generate the individual database queries, the database execution engine 120 may identify corresponding query templates stored on the database system 112 from metadata references included in the execution package and inserting parameter values included in the execution package into the corresponding query templates to form the individual database queries. The database execution engine 120 may execute individual database queries to perform a query to the product database specified by processing logic for a product at the particular stage of the manufacturing process (606).

The logic 600 shown in FIG. 6 provides an illustrative example by which a database system 112 may support query generation and execution via execution packages. Additional or alternative steps in the logic 600 are contemplated herein, including according to any of the various features described herein for the application server 102, logic packaging engine 110, database system 112, database execution engine 120, and any combinations thereof.

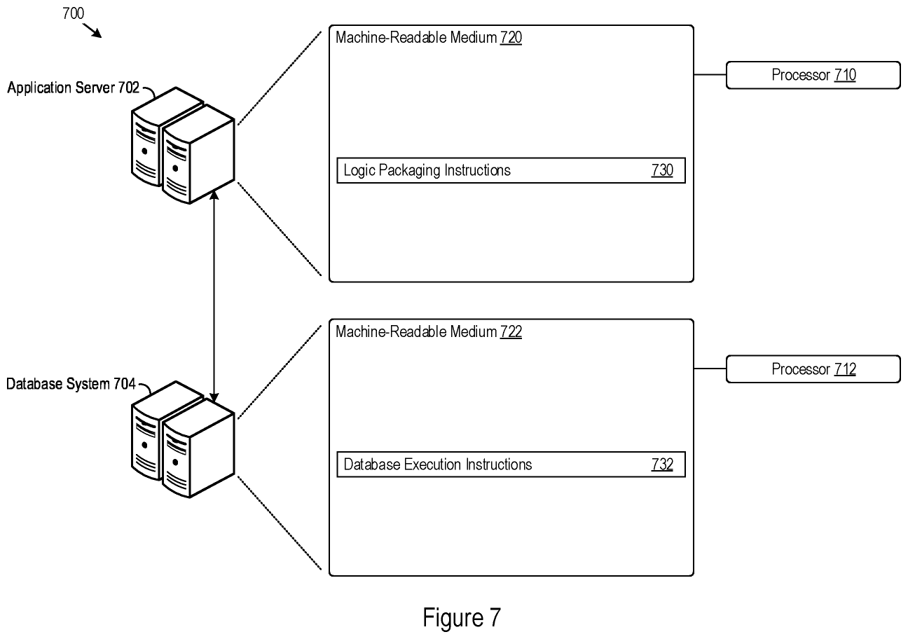

FIG. 7 shows an example of a computing system 700 that supports delta clone-based database upgrades. The computing system 700 may be a distributed computing system that implements any number of back-end capabilities of an application host. For instance, the computing system 700 may include an application server 702 and a database system 704, which may be separate physical and logical entities in the computing system 700 and include separate hardware, such as processors and memory.

The application server 702 may include a processor 710 and the database system 704 may include a processor 712, either or both of which may take the form of a single or multiple processors. The processors 710 and 712 may respectively include a central processing unit (CPU), microprocessor, or any hardware device suitable for executing instructions stored on a machine-readable medium. The application server 702 and database system 704 of the computing system 700 may each include machine-readable medium, such as the machine-readable medium 720 of the application server 702 and the machine-readable medium 722 of the database system 704. The machine-readable mediums 720 and 722 may take the form of any non-transitory electronic, magnetic, optical, or other physical storage device that stores executable instructions, such as the logic packaging instructions 730 stored on the application server 702 and the database execution instructions 732 stored in the database system 704 of FIG. 7. As such, the machine-readable medium 720 and 722 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 700 may execute instructions stored on the machine-readable mediums 720 and 722 through the processors 710 and 712. Executing the instructions (e.g., the logic packaging instructions 730 and/or the database execution instructions 732) may cause the computing system 700 to perform any of the execution package features described herein, including according to any of the features of the logic packaging engine 110, the database execution engine 120, or combinations of both.

For example, execution of the logic packaging instructions 730 by the processor 710 may cause the application server 702 to identify a product at a particular stage of a manufacturing process and extract parameter values for the product at the particular stage of the manufacturing process. Execution of the logic packaging instructions 730 may further cause the application server 702 to determine processing logic applicable to the product at the particular stage of the manufacturing process, and the processing logic may be designed to query a product database for the product based on the parameter values for the product at the particular stage of the manufacturing process. Execution of the logic packaging instructions 730 may also cause the application server 702 to generate an execution package for a database system to perform the query on the product database based on the parameter values of the product at the particular stage of the manufacturing process, and the execution package may include the parameter values for the product at the particular stage in the manufacturing process and metadata references to corresponding query templates stored on the database system. Then, execution of the logic packaging instructions 730 may cause the application server 702 to send the execution package to the database system 704.

Execution of the database execution instructions 732 by the processor 712 of the database system 704 may cause the database system 704 to receive an execution package and generate individual database queries via the execution package. To generate the individual database queries, the database execution instructions 732 may cause the database system 704 to identify corresponding query templates stored on the database system 704 from metadata references included in the execution package and inserting parameter values included in the execution package into the corresponding query templates to form the individual database queries. Execution of the database execution instructions 732 may further case the database system 704 to execute individual database queries to perform a query to the product database specified by processing logic for a product at the particular stage of the manufacturing process.

Any additional or alternative execution package features as described herein may be implemented via the logic packaging instructions 730, database execution instructions 732, or a combination of both.

The systems, methods, devices, and logic described above, including the application servers, the database systems, the logic packaging engine 110, and the database execution engine 120, may be implemented in many different ways in many different combinations of hardware, logic, circuitry, and executable instructions stored on a machine-readable medium. For example, the logic packaging engine 110, the database execution engine 120, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the logic packaging engine 110, the database execution engine 120, or combinations thereof.

The processing capability of the systems, devices, and engines described herein, including application servers, database systems, the logic packaging engine 110, and the database execution engine 120, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
identifying a product at a particular stage of a manufacturing process;
extracting parameter values for the product at the particular stage of the manufacturing process;
determining processing logic applicable to the product at the particular stage of the manufacturing process, wherein the processing logic is designed to query a product database for the product based on the parameter values for the product at the particular stage of the manufacturing process;
generating an execution package for a database system to perform the query on the product database based on the parameter values of the product, wherein the execution package comprises the parameter values for the product at the particular stage in the manufacturing process and metadata references to corresponding query templates stored on the database system; and
sending the execution package to the database system.

2. The method of claim 1, wherein generating the execution package comprises:
determining, from the processing logic applicable to the product, the corresponding query templates required to perform the query on the product database specified by the processing logic for the product at the particular stage of the manufacturing process;
retrieving the metadata references that identify the corresponding query templates; and
inserting the metadata references into the execution package.

3. The method of claim 1, wherein generating the execution package comprises linking, in the execution package, specific parameter values for the product to a particular corresponding query template that uses the specific parameter values.

4. The method of claim 1, wherein generating the execution package comprises specifying global variables in the execution package that are applicable to multiple of the corresponding query templates.

5. The method of claim 1, wherein generating the execution package comprises inserting a logic flow applicable to a particular corresponding query template, wherein the logic flow causes the database system to execute the particular corresponding query template multiple times with a different parameter value for the product for each execution.

6. The method of claim 1, further comprising: by the database system:
receiving the execution package;
generating individual database queries via the execution package; and
executing the individual database queries to perform the query to the product database specified by the processing logic for the product at the particular stage of the manufacturing process.

7. The method of claim 6, wherein generating the individual database queries comprises:
identifying the corresponding query templates from the metadata references included in the execution package; and
inserting the parameter values included in the execution package into the corresponding query templates to form the individual database queries.

8. A system comprising:
a database system comprising a product database; and
an application server comprising a logic packaging engine configured to:
identify a product at a particular stage of a manufacturing process;
extract parameter values for the product at the particular stage of the manufacturing process;
determine processing logic applicable to the product at the particular stage of the manufacturing process, wherein the processing logic is designed to query the product database for the product based on the parameter values for the product at the particular stage of the manufacturing process;
generate an execution package for the database system to perform the query on the product database based on the parameter values of the product, wherein the execution package comprises the parameter values for the product at the particular stage in the manufacturing process and metadata references to corresponding query templates stored on the database system; and
send the execution package to the database system.

9. The system of claim 8, wherein the logic packaging engine is configured to generate the execution package by:
determining, from the processing logic applicable to the product, the corresponding query templates required to perform the query on the product database specified by the processing logic for the product at the particular stage of the manufacturing process;
retrieving the metadata references that identify the corresponding query templates; and
inserting the metadata references into the execution package.

10. The system of claim 8, wherein the logic packaging engine is configured to generate the execution package by linking, in the execution package, specific parameter values for the product to a particular corresponding query template that uses the specific parameter values.

11. The system of claim 8, wherein the logic packaging engine is configured to generate the execution package by specifying global variables in the execution package that are applicable to multiple of the corresponding query templates.

12. The system of claim 8, wherein the logic packaging engine is configured to generate the execution package by inserting a logic flow applicable to a particular corresponding query template, wherein the logic flow causes the database system to execute the particular corresponding query template multiple times with a different parameter value for the product for each execution.

13. The system of claim 8 any of claims 8-12, wherein the database system further comprises a database execution engine configured to:
receive the execution package;
generate individual database queries via the execution package-; and
execute the individual database queries to perform the query to the product database specified by the processing logic for the product for the product at the particular stage of the manufacturing process.

14. The system of claim 13, wherein the database execution engine is configured to generate the individual database queries by:
identifying the corresponding query templates from the metadata references included in the execution package; and
inserting the parameter values included in the execution package into the corresponding query templates to form the individual database queries.

15. A non-transitory machine-readable medium comprising instructions that, when executed by a processor, cause a computing system to:
identify a product at a particular stage of a manufacturing process;
extract parameter values for the product at the particular stage of the manufacturing process;
determine processing logic applicable to the product at the particular stage of the manufacturing process, wherein the processing logic is designed to query a product database for the product based on the parameter values for the product at the particular stage of the manufacturing process;
generate an execution package for a database system to perform the query on the product database based on the parameter values of the product, wherein the execution package comprises the parameter values for the product at the particular stage in the manufacturing process and metadata references to corresponding query templates stored on the database system; and
send the execution package to the database system.

16. The non-transitory machine-readable medium of claim 15, wherein the instructions, when executed, cause the computing system to generate the execution package by:
determining, from the processing logic applicable to the product, the corresponding query templates required to perform the query on the product database specified by the processing logic for the product at the particular stage of the manufacturing process;
retrieving the metadata references that identify the corresponding query templates; and
inserting the metadata references into the execution package.

17. The non-transitory machine-readable medium of claim 15, wherein the instructions, when executed, cause the computing system to generate the execution package by linking, in the execution package, specific parameter values for the product to a particular corresponding query template that uses the specific parameter values.

18. The non-transitory machine-readable medium of claim 15, wherein the instructions, when executed, cause the computing system to generate the execution package by specifying global variables in the execution package that are applicable to multiple of the corresponding query templates.

19. The non-transitory machine-readable medium of claim 15, wherein the instructions, when executed, cause the computing system to generate the execution package by inserting a logic flow applicable to a particular corresponding query template, wherein the logic flow-causes the database system to execute the particular corresponding query template multiple times with a different parameter value for the product for each execution.

20. The non-transitory machine-readable medium of claim 15, wherein the computing system comprises the database system, and the instructions, when executed, cause the database system of the computing system to:
receive the execution package;
generate individual database queries via the execution package; and
execute the individual database queries to perform the query to the product database specified by the processing logic for the product for the product at the particular stage of the manufacturing process.
